(19) United States
(12) Patent Application Publication
(10) Pub. No.: US 2004/0040021 A1
(43) Pub. Date: Feb. 26, 2004

(54) Method and system for keeping an application up-to-date

(75) Inventors: Sudeep Bharati, Bellevue, WA (US); John D. Colleran, Redmond, WA (US); Jude J. Kavalam, Seattle, WA (US); Kyle P. Shannon, Redmond, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA (US)

(21) Appl. No.: 10/180,109

(22) Filed: Jun. 27, 2002

Related U.S. Application Data
(63) Continuation-in-part of application No. 10/140,213, filed on May 6, 2002.

(51) Int. Cl. G06F 9/44

(52) U.S. Cl. 717/170

(57) ABSTRACT

Disclosed are methods for keeping an application up-to-date that identify the application and the application user's specific needs to apply just the updates the user needs when the user needs them. Based on particulars of the user's computing environment, an update policy is implemented that specifies certain “triggering events” for each application to be kept up-to-date. When a triggering event occurs, the application associated with the triggering event is identified. A list is compiled of the updates already applied to the application. Another list is compiled, possibly at a remote update server, of all the updates available for the application. The lists are compared, and if an available but not yet applied update is found, then that update is sent to the user. To identify an application associated with a triggering event, the update server correlates information collected from the user's computing environment with the server's database of available updates.

### CROSS-REFERENCE TO RELATED APPLICATIONS

The present application is a continuation-in-part of U.S. patent application Ser. No. 10/140,213, “Uniquely Identifying a Crashed Application and its Environment,” filed May 6, 2002, which is incorporated herein by reference in its entirety.

### TECHNICAL FIELD

The present invention is related generally to computer applications and, more particularly, to adding an update to an application to bring the application up-to-date.

### BACKGROUND OF THE INVENTION

As computing systems become more capable and more affordable, they are able to support a continuously broadening range of software applications. Instead of getting by with a handful of applications provided by one or two vendors, users today typically use dozens of applications from almost as many sources. Many of these applications are more complex than any of the applications available just a short while ago because of their increasingly sophisticated feature sets and because of their interactions with other applications. This complexity increases both the necessity of frequent feature updates and the likelihood of errors which require error correction updates. The result is that users are subjected to an ever-growing number of updates for their applications.

At the same time that they are running more applications, users are demanding quicker updates to those applications. To keep their applications up-to-date, users would like to receive functional improvements and error fixes as soon as they are developed rather than waiting for the traditional annual or semi-annual “point releases.”

To create a point release, a software vendor packages all of the updates and error fixes for all of the vendor's applications (or at least all of the applications in a related suite of applications). (Operating system updates are usually handled separately from application updates.) Each of the vendor's customers then receives this entire package, regardless of which applications a particular customer uses. Installation software extracts from the point release package those updates targeted to the applications used by the customer. Because of its coverage of so many applications, a point release package can be enormous, totaling tens, if not hundreds, of megabytes.

Fortunately, the increased storage available with CD-ROMs has eliminated the nightmare of loading updates from a stack of dozens of floppy disks. However, the size of a typical point release is again a problem because vendors would like to make downloading updates from Internet sites the new standard for updating software applications. Bandwidth for downloading software updates is still a precious resource, a resource that users do not want to waste for updates to applications that they do not run. Ideally, a user would be able to download only those updates pertinent to the applications run by the user.

There are at least two problems with providing to users only the updates they want. The first problem comes in identifying which applications to update. A software application is made up of several parts, the core application code, utilities, and shared software libraries. Any or all of these may need to be updated, and it is not always clear which updates apply to which files. One application may be affected by the other applications run by the user. For example, a shared library may be updated appropriately for one application, but cease to work properly for another application. Resolving this problem requires information about the shared library and about both of the applications. The requisite fix may require updates to any or all of these software modules. Also, which updates are appropriate to a user depends on the details of the user's computing environment. For example, an update to an operating system may create incompatibilities between the operating system and an application. Without knowing the operating system and other information about the user's computing environment, determining the proper update to resolve the incompatibility may be impossible.

A second problem is knowing when to update the user's applications. While the application's vendors knows when updates become available, the vendor does not know the details of the user's computing environment that dictate when updates should be applied. These details may not even be known to the user.

What is needed is a method for identifying the updates necessary for bringing an application up-to-date, given the application user's computing environment, and a method for bringing just those updates to the application.

### SUMMARY OF THE INVENTION

In view of the foregoing, the present invention provides a method for keeping an application up-to-date that identifies the application and the application user's specific needs to apply just the updates the user needs when the user needs them. Based on the particulars of the user's computing environment, an update policy is implemented that specifies certain “triggering events” for each application to be kept up-to-date. When a triggering event occurs, the application associated with the triggering event is identified. A list is compiled of the updates already applied to the application. Another list is compiled, possibly at a remote update server, of all the updates available for the application. The lists are compared, and if an available but not yet applied update is found for the application, then that update is sent to the user. The update is applied to the application. Only updates needed by the user are sent, and they are sent when the user's environment is set to accommodate them.

Update policy reflects the particular characteristics of the user's computing environment. To coordinate system administration, a large corporate client can set a triggering event to periodically query the update servers, say once every weekend, and apply all new updates before the actual users return to work. In other environments, a triggering event can be set to query for new updates whenever a less frequently used application is invoked. The updates are downloaded and applied, and then the application is started with the new updates in place.

In order to identify an application associated with a triggering event, information is collected from the user's computing environment. The information can include an inventory of selected files, including the application's executable file and dynamic link libraries, and system properties of the user's computing device. In some user environments, this collected information, along with the list of already applied updates, is sent to the update server. The update server correlates the information with its database of available updates. Available but not yet applied updates for the application are identified and sent to the user.

The update servers can be Web sites hosted by application vendors or by separate support organizations. Individual users can contact the Web sites directly for updates. For ease of administration, a corporate client can set up an in-house update server, updating that server from the vendor sites and then using the in-house server to update the corporation's computing devices.

Vendors can set authorization policies. For example, updates are only sent to users who have a valid service agreement in place with the vendor.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 is a block diagram showing an exemplary computing environment in which an update client computing device communicates with update servers in order to keep its application programs up-to-date;

FIG. 2 is schematic diagram generally illustrating an exemplary computing system that supports the present invention; and

FIGS. 3a and 3b together form a flowchart showing an exemplary method according to the present invention for keeping application programs up-to-date.

### DETAILED DESCRIPTION OF THE INVENTION

Turning to the drawings, wherein like reference numerals refer to like elements, the present invention is illustrated as being implemented in a suitable computing environment. The following description is based on embodiments of the invention and should not be taken as limiting the invention with regard to alternative embodiments that are not explicitly described herein.

In the description that follows, the present invention is described with reference to acts and symbolic representations of operations that are performed by one or more computing devices, unless indicated otherwise. As such, it will be understood that such acts and operations, which are at times referred to as being computer-executed, include the manipulation by the processing unit of the computing device of electrical signals representing data in a structured form. This manipulation transforms the data or maintains them at locations in the memory system of the computing device, which reconfigures or otherwise alters the operation of the device in a manner well understood by those skilled in the art. The data structures where data are maintained are physical locations of the memory that have particular properties defined by the format of the data. However, while the invention is being described in the foregoing context, it is not meant to be limiting as those of skill in the art will appreciate that various of the acts and operations described hereinafter may also be implemented in hardware.

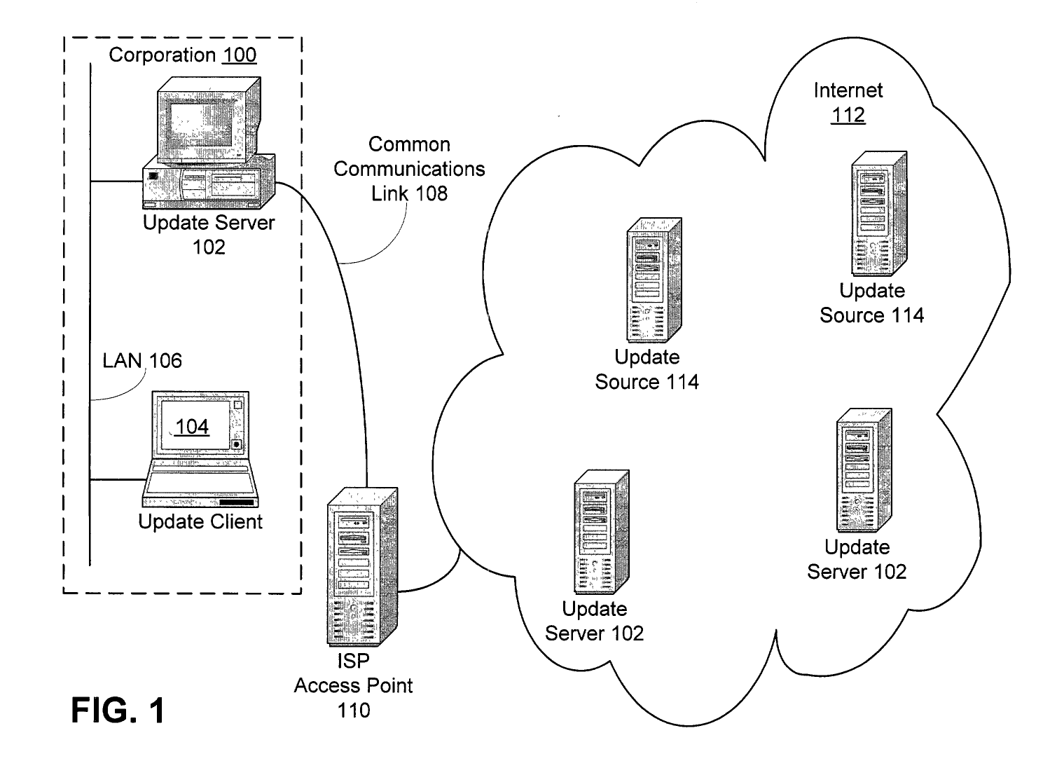

FIG. 1 presents a rather elaborate environment for providing updates to application programs. Within a corporation 100, the system administrators have set up an in-house update server 102. The computing devices that run the applications to be kept up-to-date are called “update clients” and are represented in FIG. 1 by a single device 104. While represented in FIG. 1 as the laptop computer 104, the update clients 104 in a corporation 100 can range from small, hand-held devices through desktop or laptop personal computers through the largest mainframes and servers. The corporation 100 can have thousands of diverse update clients 104 and several in-house update servers 102 all connected by internal communications networks such as the local area network (LAN) 106.

The corporation 100's in-house update server 102 uses a common communications link 108 to connect, through an Internet Service Provider (ISP) Access Point 110, to update servers 102 on the Internet 112. Also on the Internet 112 are update sources 114. These sites are run by vendors of application programs. Vendors create updates to their applications and provide the updates, through the update servers 102, to their customers. Some vendors run their own update service and implement the update source 114 and update server 102 on the same computing device. Other vendors contract with independent third parties to provide update services. These vendors populate the third-party update servers 102 with updates from the vendors' update sources 114.

When an application program running on an update client 104 needs to be updated (how that can be determined is discussed below), updates are sent from the in-house update server 102 via the LAN 106 to the update client 104. There, the updates are applied to the application program. The in-house update server 102 periodically communicates with the update servers 102 on the Internet 112 to receive the latest updates for all of the applications that run on the update clients 104 in the corporation 100.

Few small corporations or home users support an in-house update server 102 as shown in FIG. 1. Rather, their update clients 104 communicate directly with one or more update servers 102 on the Internet 112.

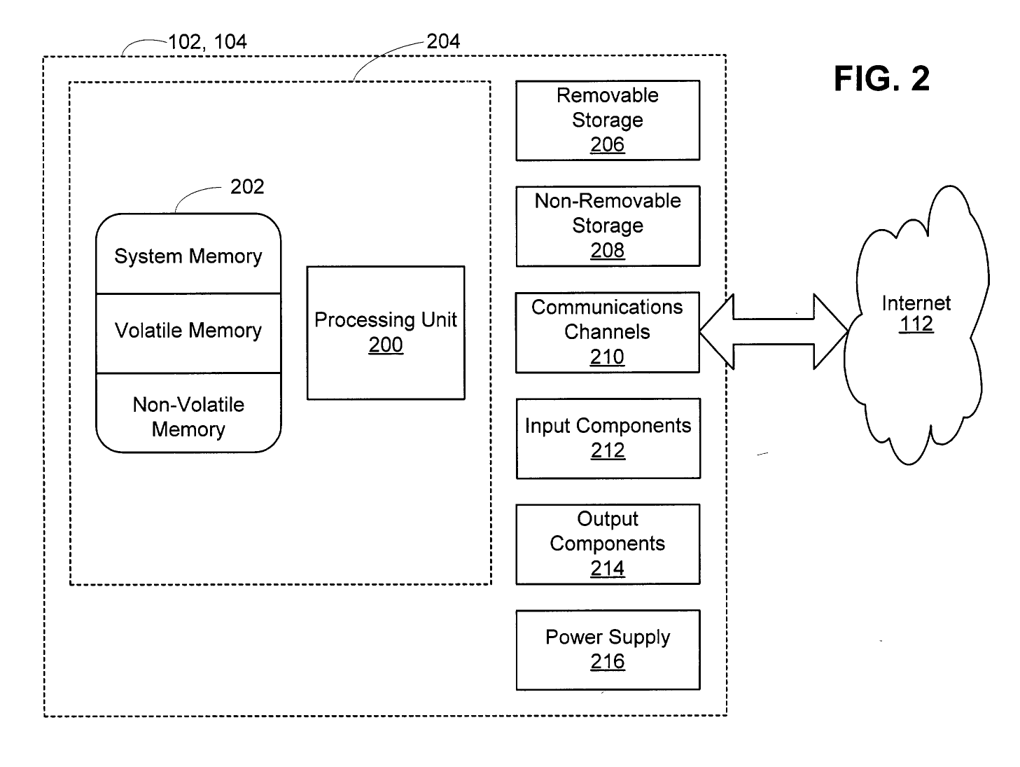

The update servers 102 and update client 104 of FIG. 1 may be of any architecture. FIG. 2 is a block diagram generally illustrating an exemplary computer system that supports the present invention. The computer system of FIG. 2 is only one example of a suitable environment and is not intended to suggest any limitation as to the scope of use or functionality of the invention. Neither should the update client 104 be interpreted as having any dependency or requirement relating to any one or combination of components illustrated in FIG. 2. The invention is operational with numerous other general-purpose or special-purpose computing environments or configurations. Examples of well known computing systems, environments, and configurations suitable for use with the invention include, but are not limited to, personal computers, servers, hand-held or laptop devices, multiprocessor systems, microprocessor-based systems, set-top boxes, programmable consumer electronics, network PCs, minicomputers, mainframe computers, and distributed computing environments that include any of the above systems or devices. In its most basic configuration, the update client 104 typically includes at least one processing unit 200 and memory 202. The memory 202 may be volatile (such as RAM), non-volatile (such as ROM or flash memory), or some combination of the two. This most basic configuration is illustrated in FIG. 2 by the dashed line 204. The update client 104 may have additional features and functionality. For example, the update client 104 may include additional storage (removable and non-removable) including, but not limited to, magnetic and optical disks and tape. Such additional storage is illustrated in FIG. 2 by removable storage 206 and non-removable storage 208. Computer-storage media include volatile and non-volatile, removable and non-removable, media implemented in any method or technology for storage of information such as computer-readable instructions, data structures, program modules, or other data. Memory 202, removable storage 206, and non-removable storage 208 are all examples of computer-storage media. Computer-storage media include, but are not limited to, RAM, ROM, EEPROM, flash memory, other memory technology, CD-ROM, digital versatile disks, other optical storage, magnetic cassettes, magnetic tape, magnetic disk storage, other magnetic storage devices, and any other media that can be used to store the desired information and that can be accessed by the update client 104. Any such computer-storage media may be part of the update client 104. The update client 104 may also contain communications channels 210 that allow the device to communicate with other devices. Communications channels 210 are examples of communications media. Communications media typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include optical media, wired media, such as wired networks and direct-wired connections, and wireless media such as acoustic, RF, infrared, and other wireless media. The term “computer-readable media” as used herein includes both storage media and communications media. The update client 104 may also have input devices 212 such as a keyboard, mouse, pen, voice-input device, touch-input device, etc. Output devices 214 such as a display, speakers, and printer may also be included. All these devices are well know in the art and need not be discussed at length here.

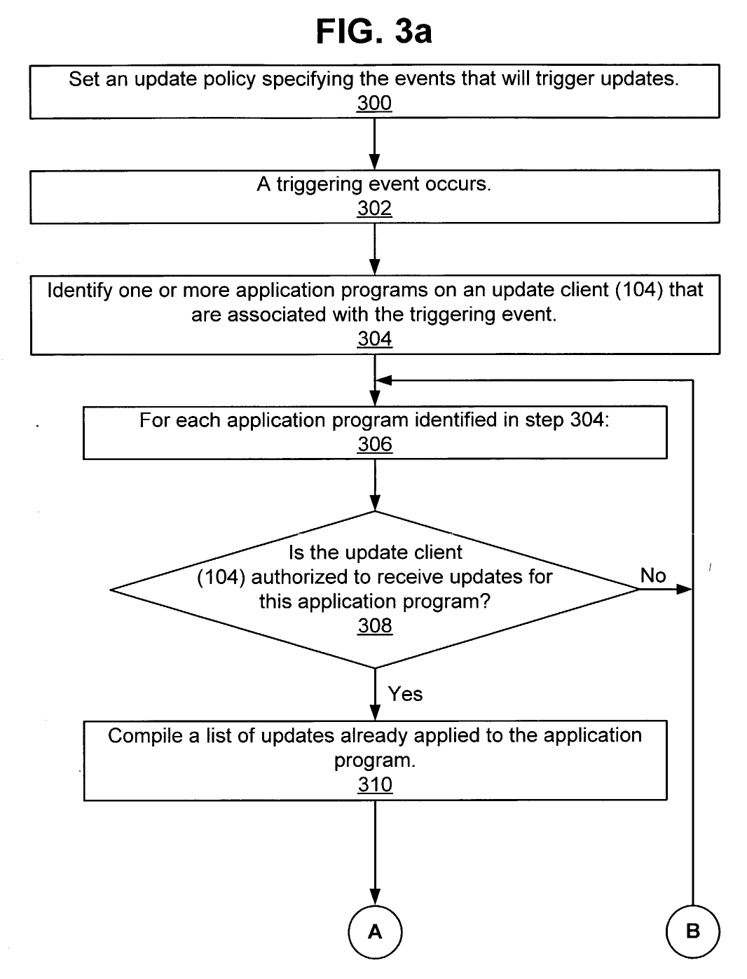

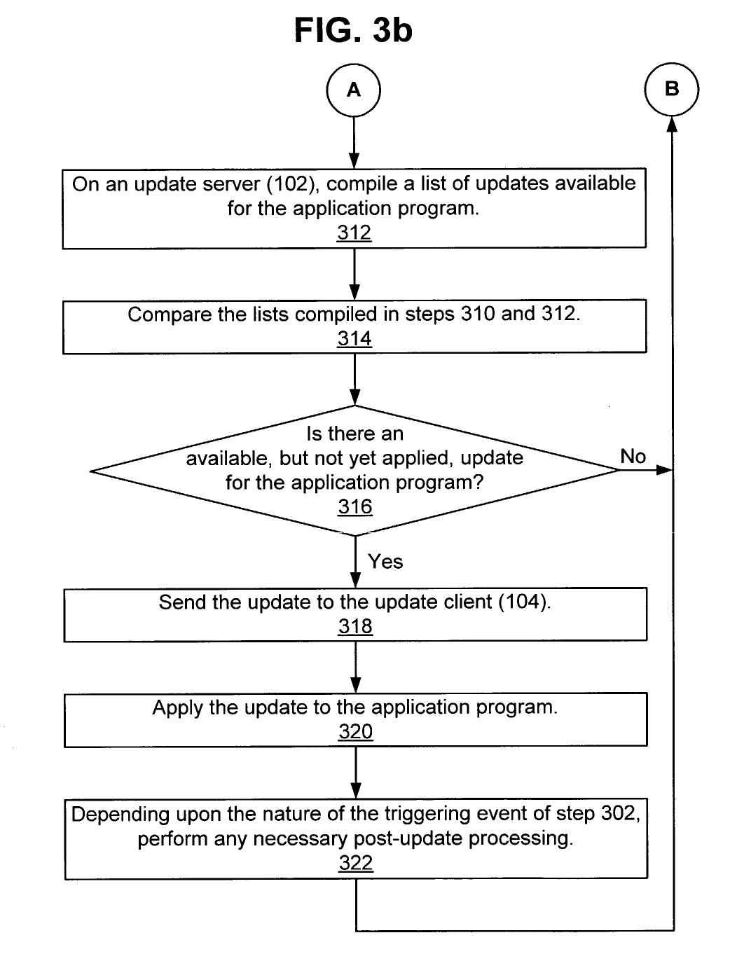

FIGS. 3a and 3b together present an exemplary method according to aspects of the present invention for keeping application programs up-to-date. Note that some of the steps in this flowchart are performed on the update client 104, some on the update server 102, some may be performed on either, and some can be omitted, depending upon the particular circumstances of the user's computing environment.

The method begins in step 300 where the user explicitly or implicitly sets a policy for when, how, and if applications running on the update client 104 are to be updated. There are numerous ways known in the art for setting policy including, for example, rules compilers. Each application can be subject to one or more policy rules, and different applications can be subject to different update policies. In one aspect of setting the update policy, the user specifies “triggering events” for applications to be kept up-to-date. As described below, the update process can be initiated by the occurrence of one of these triggering events. The set of possible triggering events is limited only by the imagination. As a first example, the triggering event could simply be the availability of a new update on an update server 102. With this trigger, the update server 102 “pushes” updates to the update client 104 as soon as the new updates become available. Another trigger can be the passage of time. This is the situation described above in reference to FIG. 1 where the corporate in-house update server 102 pushes new updates periodically, say once a week, to all the update clients 104 under its purview. A third trigger can be set to go off whenever a user invokes an application program. The invocation is suspended until the update procedure, described below, is complete. Then the invocation is allowed to proceed, and the application with the new updates incorporated into it is run. Of course, this trigger is more acceptable when the updates can be found and applied to the application program almost instantaneously so the user need not wait for the application to begin. Finally, the trigger could simply be the user explicitly requesting any available updates.

In any case, the update method actually begins in step 302 when the triggering event occurs. In some cases, such as the application program invocation trigger, software on the update client 104, such as the MICROSOFT'S “WATSON,” may detect the occurrence of the trigger and may invoke a software utility to perform the remainder of the method of FIGS. 3a and 3b.

The application programs associated with the triggering event of step 302 are identified in step 304. Because it is sometimes difficult to identify the correct application program, in some embodiments information is collected from the update client 104 and from that client's computing environment in order to identify the application precisely. The information collected includes, first, an inventory of selected files including files from a directory that includes the executable image of the application program. Other directories instead of or in addition to this one can be inventoried. The files selected for the inventory can include executables, dynamic link libraries, configuration files, and history files. The inventory includes, for each file in the inventory, the file's name, size, and a checksum. The inventory can also include a list of system properties and their values. Such properties can include the name of the operating system of the update client 104, the version of that operating system, the name of the manufacturer of the update client 104, and the type of processing unit 200 of the update client 104. A more complete list is given below in the example in the description of step 312 of FIG. 3b.

The loop beginning at step 306 is performed for each application program identified in step 304. Note that the precise layout of this loop is for illustrative purposes only. In some embodiments, the steps of the loop are performed in an order different from the one shown in FIGS. 3a and 3b, and some steps can be performed concurrently.

Step 308 checks to see whether the user of the update client 104 is authorized to receive updates for the application programs identified in step 304. Both home users and corporate clients ordinarily pay for an update support service agreement. (Some vendors include, say, a year's worth of updates with the purchase price of application software.) This support agreement is checked in step 308 (probably on an update server 102), and updates are only sent to users who have a current agreement in place. Some third-party support providers contract to provide the latest updates from a multiplicity of vendors so that users need not maintain several individual agreements. The methods of the present invention work well with the emerging paradigm wherein software applications are not purchased outright, but are “leased” for a set period of time, the lease including all updates made available during that time.

In step 310, a list is compiled of all updates currently applied to the application program. In some embodiments, the list is created by searching through directories for evidence of past updates. For application programs where updates must be applied in a certain order, the “list” is simply an indication of the latest update applied. Step 310 can be performed on the update client 104, but need not be. An update server 102, especially an in-house one, can keep records of the updates already applied.

In step 312 of FIG. 3b, another list is compiled. This is the list of updates available for the application program. There is no implication that this list is compiled in response to the triggering event: it can exist independently of any triggering event. One aspect of step 312 is knowing which is the appropriate application program. The information collected in step 304 comes into play here. That information is examined by the update server 102 to know which application it needs to update.

To get the information collected in step 304 to the update server 102, the inventory of collected information is formatted according to some specification, such as the Extensible Markup Language (XML) format. For example, the following is an exemplary XML inventory of selected files for the MICROSOFT “MONEY” application program. This application has an executable version named “msmoney.exe” and, only for purposes of the current illustration, has a single dynamic link library file named “msofd.dll.”

<?xml version=“1.0” encoding=“UTF-16”?>

<DATABASE>

<EXE NAME=“msmoney.exe” FILTER=“GRABMI_FILTER_NORMAL”>

<MATCHING_FILE NAME=“msmoney.exe” SIZE=“28715” CHECKSUM=“0xF49D41E2”

BIN_FILE_VERSION=“9.0.0.715” BIN_PRODUCT_VERSION=“9.0.0.715”

PRODUCT_VERSION=“9.00.0715” FILE_DESCRIPTION=“Microsoft Money”

COMPANY_NAME=“Microsoft Corporation” PRODUCT_NAME=“Microsoft Money”

FILE_VERSION=“9.00.0715”

ORIGINAL_FILENAME=“MSMoney.EXE” INTERNAL_NAME=“MSMoney”

LEGAL_COPYRIGHT=“Copyright (C) Microsoft Corp. 1990-2000. All rights reserved.”

VERFILEDATEHI=“0x0” VERFILEDATELO=“0x0” VERFILEOS=“0x4”

VERFILETYPE=“0x1” MODULE_TYPE=“WIN32” PE_CHECKSUM=“0x0”

LINKER_VERSION=“0x0” UPTO_BIN_VERSION=“9.0.0.715”

UPTO_BIN_PRODUCT_VERSION=“9.0.0.715”

LINK_DATE=“07/15/2000 03:17:42” UPTO_LINK_DATE=“07/15/2000 03:17:42”

VER_LANGUAGE=“English (United States) [0x409]”>

<MATCHING_FILE NAME=“msofd.dll” SIZE=“1962028” CHECKSUM=“0x96F7EOE4”

BIN FILE VERSION=“9.0.0.715” BIN PRODUCT VERSION=“9.0.0.715”

PRODUCT VERSION=“9.00.0715” FILE_DESCRIPTION=“Microsoft OFD Interface Library”

COMPANY_NAME=“Microsoft Corporation” PRODUCT_NAME=“Microsoft Money”

FILE VERSION=“9.00.0715”

ORIGINAL_FILE_NAME=“MSOFD.DLL” INTERNAL_NAME=“MSOFD”

LEGAL_COPYRIGHT=“Copyright (C) Microsoft Corp. 1990-2000. All rights reserved.”

VERFILEDATE=“0x0” VERFILEDATELO=“0x0” VERFILEOS=“0x4”

VERFILETYPE=“0x2” MODULE_TYPE=“WIN32” PE_CHECKSUM=“0x1EDC68”

LINKER_VERSION=“0x0” UPTO_BIN_FILE_VERSION=“9.0.0.715”

UPTO_BIN_PRODUCT_VERSION=“9.0.0.715”

LINK_DATE=“07/15/2000 04:45:12” UPTO_LINK_DATE=“07/15/2000 04:45:12”

VER_LANGUAGE=“English (United States) [0x409]”>

The following are descriptions of a few of the above XML fields.

MATCHING_FILE NAME: the name of the file in the inventory;

SIZE: the size of the file in bytes;

BIN_FILE_VERSION: the version of the binary file, if applicable;

BIN_PRODUCT_VERSION: the version of the binary file for the product, if applicable;

COMPANY_NAME: the name of the file's developer;

PRODUCT_NAME: the name of the application program;

INTERNAL_NAME: a name by which the file may be referred to internally by the developer;

VERFILEDATEHI, VERFILEDATELO: file date information;

VERFILEOS: the version of the operating system;

VERFILETYPE: the file type;

LINKER_VERSION: the version of the linker used in conjunction with the file; and

VER_LANGUAGE: the natural language of the file version (e.g., English).

An inventory of properties of the update client 104 can be formatted in XML as follows.

<SYS_INFO NAME=“OS Name” VALUE=“Microsoft Windows XP Professional”>

<SYS_INFO NAME=“Version” VALUE=“5.1.2505 Build 2505”/>

<SYS_INFO NAME=“OS Manufacturer” VALUE=“Microsoft Corporation”/>

<SYS_INFO NAME=“System Name” VALUE=“TEST1”/>

<SYS_INFO NAME=“System Manufacturer” VALUE=“Dell Computer Corporation”/>

<SYS_INFO NAME=“System Model” VALUE=“XPS-Z”/>

<SYS_INFO NAME=“System Type” VALUE=“X86-based PC”/>

<SYS_INFO NAME=“Processor” VALUE=“x86 Family 6 Model 8 Stepping 6 GenuineIntel ˜930 Mhz”/>

<SYS_INFO NAME=“BIOS Version/Date” VALUE=“Intel Corp. A05, 9/22/2000”/>

<SYS_INFO NAME=“SMBIOS Version” VALUE=“2.3”/>

<SYS_INFO NAME=“Windows Directory” VALUE=“C:\RC1”/>

<SYS_INFO NAME=“System Directory” VALUE=“C:\RC1\System32”/>

<SYS_INFO NAME=“Boot Device” VALUE=“\Device\Harddisk Volume 1”/>

<SYS_INFO NAME=“Locale” VALUE=“United States”/>

</DATABASE>

The above XML fields have the following meanings.

OS Name: the name of the operating system on the update client 104;

Version: the version of the operating system;

OS Manufacturer: the manufacturer of the operating system;

System Name: the name of the update client 104, if any;

System Manufacturer: the manufacturer of the update client 104;

System Model: the model of the update client 104;

System Type: the type of the update client 104;

Processor: the model of processing unit 200;

BIOS Version/Date: the version and date of the Basic Input/Output System (BIOS);

SMBIOS Version: the version and date of the System Management BIOS;

Windows Directory: the directory path containing the operating system software;

System Directory: the directory path containing the system directory for the operating system;

Boot Device: the storage device from which the update client 104 boots; and

Locale: a geographic location of the update client 104.

When the update server 102 has the file and system property inventory information collected in step 304, the information is compared against a database of application identification information. The comparison tells the update server 102 which available updates are appropriate to this application program.

In steps 314 and 316, the list of already applied updates is compared against the list of available updates. Available but not yet applied updates are sent in step 318 to the update client 104 which applies them to the application program in step 320.

When the triggering event of step 302 is an invocation of the application program, then after the updates are applied in step 320, the updated application program is run in step 322.

In view of the many possible embodiments to which the principles of the present invention may be applied, it should be recognized that the embodiments described herein with respect to the drawing figures are meant to be illustrative only and should not be taken as limiting the scope of the invention. Those of skill in the art will recognize that some implementation details, such as the contents and formats of the inventories, are determined by the computing environment found in specific situations. Although the invention is described in terms of software modules or components, some processes may be equivalently performed by hardware components. Therefore, the invention as described herein contemplates all such embodiments as may come within the scope of the following claims and equivalents thereof.

We claim:

1. In a computing environment with a client computing device and with one or more update servers, a method for applying an update to an application program on the client, the method comprising:
upon an invocation to run an application program on the client, identifying the application program;
compiling a list of updates already applied to the application program;
compiling, by an update server, a list of updates available for the application program;
comparing, by an update server, the list of available updates to the list of already applied updates; and
if the comparing reveals a first available update that has not yet been applied to the application program, then sending, by an update server to the client, the first available update and applying, by the client, the first available update to the application program.

2. The method of claim 1 wherein the method further comprises running the application program on the client after applying the first available update to the application program.

3. The method of claim 1 wherein identifying an application program comprises:
compiling, on the client, an inventory of files stored in a directory on the client that contains an executable file of the application program;
compiling, on the client, an inventory of system properties of the client;
sending, by the client to an update server, the inventory of files and the inventory of system properties; and
comparing, on an update server, the inventory of files and the inventory of system properties with application program data on the update server.

4. The method of claim 3 wherein the compiled inventory of files consists of the executable file of the application program.

5. The method of claim 3 wherein compiling an inventory of files comprises compiling properties of the files, the properties including file name, file size, and file checksum.

6. The method of claim 3 wherein sending the inventory of files and the inventory of system properties comprises writing the inventory of files and the inventory of system properties in an Extensible Markup Language format.

7. The method of claim 1 wherein compiling a list of updates already applied is performed on the client.

8. The method of claim 7 wherein compiling a list of updates already applied comprises examining an executable file of the application program.

9. The method of claim 1 wherein compiling a list of updates already applied is performed on an update server.

10. The method of claim 1 wherein comparing comprises revealing a second available update that has not yet been applied to the application program, the method further comprising sending, by an update server to the client, the second available update and applying, by the client, the second available update to the application program.

11. The method of claim 10 wherein the first available update depends upon the second available update.

12. The method of claim 1 further comprising checking, on an update server, an authorization of the client to receive the first available update and wherein sending the first available update is performed only if the client is authorized to receive the first available update.

13. The method of claim 1 further comprising setting, by a user of the client, an update policy.

14. A computer-readable medium containing computer-executable instructions for performing, in a computing environment with a client computing device and with one or more update servers, a method for applying an update to an application program on the client device, the method comprising:
upon an invocation to run an application program on the client, identifying the application program;
compiling a list of updates already applied to the application program;
compiling, by an update server, a list of updates available for the application program;
comparing, by an update server, the list of available updates to the list of already applied updates; and
if a first available update has not yet been applied to the application program, then sending, by an update server to the client, the first available update and applying, by the client, the first available update to the application program.

15. The computer-readable medium of claim 14 wherein the method further comprises running the application program on the client after applying the first available update to the application program.

16. The computer-readable medium of claim 14 wherein identifying an application program comprises:
compiling, on the client, an inventory of files stored in a directory on the client that contains an executable file of the application program;
compiling, on the client, an inventory of system properties of the client;
sending, by the client to an update server, the inventory of files and the inventory of system properties; and
comparing, on an update server, the inventory of files and the inventory of system properties with application program data on the update server.

17. The computer-readable medium of claim 14 wherein the method further comprises checking, on an update server, an authorization of the client to receive the first available update and wherein sending the first available update is performed only if the client is authorized to receive the first available update.

18. In a computing environment with a client computing device and with one or more update servers, a method for the client to apply an update to an application program on the client, the method comprising:
upon an invocation to run an application program on the client, identifying the application program;
receiving from an update server a first available update for the application program that has not yet applied to the application program; and
applying the first available update to the application program.

19. The method of claim 18 wherein the method further comprises running the application program on the client after applying the first available update to the application program.

20. The method of claim 18 wherein identifying an application program comprises:
compiling an inventory of files stored in a directory on the client that contains an executable file of the application program;
compiling an inventory of system properties of the client; and
sending to an update server the inventory of files and the inventory of system properties.

21. The method of claim 20 wherein the compiled inventory of files consists of the executable file of the application program.

22. The method of claim 20 wherein compiling an inventory of files comprises compiling properties of the files, the properties including file name, file size, and file checksum.

23. The method of claim 20 wherein sending the inventory of files and the inventory of system properties comprises writing the inventory of files and the inventory of system properties in an Extensible Markup Language format.

24. The method of claim 18 further comprising compiling a list of updates already applied to the application program.

25. The method of claim 24 wherein compiling a list of updates already applied comprises examining an executable file of the application program.

26. The method of claim 18 further comprising:
receiving from an update server a second available update for the application program that has not yet been applied to the application program; and
applying the second available update to the application program.

27. The method of claim 26 wherein the first available update depends upon the second available update.

28. The method of claim 18 further comprising setting, by a user of the client, an update policy.

29. A computer-readable medium containing computer-executable instructions for performing, in a computing environment with a client computing device and with one or more update servers, a method for the client to apply an update to an application program on the client, the method comprising:
upon an invocation to run an application program on the client, identifying the application program;
receiving from an update server a first available update for the application program that has not yet applied to the application program; and
applying the first available update to the application program.

30. The computer-readable medium of claim 29 wherein the method further comprises running the application program on the client after applying the first available update to the application program.

31. The computer-readable medium of claim 29 wherein identifying an application program comprises:
compiling an inventory of files stored in a directory on the client that contains an executable file of the application program;
compiling an inventory of system properties of the client; and
sending to an update server the inventory of files and the inventory of system properties.
